(19) United States
(12) Patent Application Publication
(10) Pub. No.: US 2021/0153045 A1
(43) Pub. Date: May 20, 2021

(54) SMALL CELL WITH PUBLIC SAFETY COMPLIANT CHARACTERISTICS

(71) Applicant: Ricardo Matias de Goycoechea, Cordoba (AR)

(72) Inventor: Ricardo Matias de Goycoechea, Cordoba (AR)

(21) Appl. No.: 17/097,984

(22) Filed: Nov. 13, 2020

Related U.S. Application Data
(60) Provisional application No. 62/935,469, filed on Nov. 14, 2019.

(51) Int. Cl. H04W 24/08; H04W 24/02

(52) U.S. Cl. CPC H04W 24/08; H04W 24/02

(57) ABSTRACT

A small cell system compliant with NEMA4 or NEMA4X standards is disclosed. The system may include a small cell; one or more backhaul connections to the small cell; one or more DC sources to power the small cell; an antenna port; first circuitry for measuring RF output power from the small cell; second circuitry for measuring VSWR between the small cell and the antenna port; third circuitry for measuring said power to the small cell from the one or more DC sources; fourth circuitry for determining the status of the one or more back haul connections; and a dry contact for outputting an alarm. The dry contact may be connected to at least one of the first, second, third or fourth circuitries.

### CROSS REFERENCE TO RELATED APPLICATIONS

This application claims the benefit of U.S. Provisional Application No. 62/935,469 filed Nov. 14, 2019, the disclosure of which is hereby incorporated herein by reference in its entirety.

### FIELD OF THE INVENTION

Embodiments of the present invention generally relate to a system and method for providing alarms as part of In Building Wireless (IBW) services.

### BACKGROUND

One of the operational backbones of Public Safety Agencies (PSAs) is their communications systems. Those communication systems enable the Public Safety Agencies to exchange information in real time, coordinate tasks of different operating groups, allow the agencies to attend to and deal with emergency situations, coordinate their personnel locally or remotely, and collaborate in orderly fashion with other Public Safety Agencies. Within the communications field, telecommunications in particular facilitate the provision of services that allow the aforementioned objectives to be met, since, through electromagnetic waves, information is sent from one point to another, either as an audio message or digital data.

Telecommunications systems are growing or expanding constantly following the end user needs. New technologies that can manage more data at high speed rates, new frequency bands that allow systems to operate with larger bandwidths, and new network topologies constitute the main changes or advances in the telecommunications industry. But both older systems and the newer systems have the same limitations with respect to signal propagation through air. These limitations are imposed by the laws of Physics, which apply to the propagation of radio frequency (“RF”) signals regardless of the technology being used. When it is desired to enable RF communications with RF devices in a closed area, or “indoor areas” as referred to in the telecommunications industry, the RF signals have to penetrate through physical barriers such as walls, roofs, furniture, among others, which severely attenuate the RF signals, resulting in a reduction of the RF signal amplitude to levels that may not allow achieving a good quality of communication service. Often times, the physical barriers attenuate RF signals transmitted from an outside area or generate a multipath effect so severe that communicating with radios in the indoor are becomes impossible.

To address these limitations imposed by the laws of Physics, telecommunications systems rely on different solutions which may be based on products that retransmit the system channels, such as Signal Boosters, Bidirectional Amplifiers and Fiber DAS systems, or which may be based on Base Transceiver Stations (BTSs) installed at the location where communications with indoor radios are required to be available, and with a high level of quality and reliability. The difference between installing a Signal Booster/BDA/Fiber DAS and installing a local BTS is that in the first option these products (Signal Booster/BDA/Fiber DAS) extend the coverage of the donor BTS (donor BTS may be defined as the signal source, typically intended to cover an outdoor area such as a city or town or county) by receiving signals from the donor BTS through a donor antenna, amplifying the received signals, and retransmitting the received signals to the indoor area to provide coverage via indoor antennas located at specific places within the indoor target area. Terminal units (TU) such as cellphones, radios, among others, are located inside indoor areas. In that scenario, the signal from donor BTS to the TU is referred to as the downlink (DL) signal.

In the opposite direction, the Signal Booster/BDA/Fiber DAS receives through indoor antennas the signals transmitted by the TUs located in the indoor target area, amplifies the received signals, and retransmits them to the donor BTS through a donor antenna. In some situations, the link or connection between the donor BTS and the Signal Booster/BDA/Fiber DAS can be replaced by another physical connection, including coaxial cables, fiber optical links, among others. The signal from TUs to the donor BTS is referred to as the uplink (UL) signal.

The alternative solution or option conventionally applied is based on the use or placement of a local BTS that is installed within or inside the indoor target area (as the local BTS should be as close as possible to the TU located within the closed area). The local BTS is connected by any backbone link with the BTS network in order to receive and transmit the data (which includes data and calls), and locally provides the capacity required by the TUs to operate. The local BTS generates the RF signals that are to be transmitted or radiated into the indoor target area by use of one or multiple indoor antennas in the DL direction, and receives through the same indoor antennas the UL signals from the TUs. This local BTS can be implemented with a land mobile radio (LMR) BTS, with a cellular BTS or eNodeB, with a Remote Radio Unit (RRU), or with a Small Cell.

PSAs constitute a category of users of the telecommunications services that require indoor coverage. PSAs require use of telecommunications services in order to coordinate operations, and following the same needs as the market, PSAs require reliable and high-quality telecommunications services to be available in every indoor location within the PSA territory. These services may be referred to as In Building Wireless (IBW) services.

The term “Authority Having Jurisdiction” or “AHJ” may be defined as the PSA authority that dictates the regulations that the IBW systems must meet for the PSA. The AHJ may be a federal, state, local, or other regional department or individual such as a fire chief; fire marshal; chief of a fire prevention bureau, labor department, or health department; building official; electrical inspector; or others having statutory authority. Besides the mandatory compliance to federal regulations like FCC, AHJ typically bases its local additional regulations that the PSA IBW systems must meet on existing codes and standards, such as the National Fire Protection Agency (NFPA) code, among others. These codes and standards set forth standards for high reliability and safety of the systems, and besides stating requirements, they also dictate the manner in which a IBW system, as an entire system or based on individual components, must report its status and failures. A standard reporting method can be implemented via an IP connection that enables reporting the status and alarms using the SNMP protocol. Alternatively, reports can be sent to a server via a modem, or can be sent to another system via any wired or wireless connection such as an USB connection, Bluetooth connection or WiFi connection, among others.

In reality, what the AHJ requires is a simpler reporting method, where reporting is conducted through dry contacts that are connected to a fire alarm panel, where the fire alarm panel senses the status of those dry contacts to determine if a failure is being reported by the IBW system, integrating those alarms within the fire alarming system report. A dry contact refers to “volt free”—it is not “wetted” by a voltage source. A dry contact can refer to a secondary set of contacts of a relay circuit which does not make or break the primary current being controlled by the relay. Usually some other contacts or devices function to initiate/start or stop the primary current being controlled. For example, a reed relay matrix switch is normally switched with all contacts dry. After the contacts are all connected, a wire spring relay is energized and connects a supervisory scan point, or main switch, through which the primary current being controlled then flows. Dry contacts are primarily employed in 49 volt or less (extra-low voltage) distribution circuits.

The NFPA code states some of the conditions that the PSA IBW system must report. The PSA IBW system may include a Signal Booster or Fiber DAS system, and a Battery Backup Unit (BBU) that can provide the Signal Booster of Fiber DAS with backup power for a certain amount of time in the event the electricity supply system is interrupted, such that the PSA IBW can remain operational. Typical reported alarms include the Donor Antenna Failure, Service Antenna voltage standing wave ratio (VSWR), Battery Backup Failure, among others. However, there is a new challenge related to the application of small cells as a part of a PSA IBW system, since small cells are not configured or designed to support the type of reporting alarms that a traditional PSA IBW system requires. Thus, there are challenges related to reporting an alarm related to any failure of the small cell system, be it the small cell system, each individual part of the small cell system, or the entire system comprised of the small cell, the small cell backhaul, the small cell power supply system (main and backup), and the small cell radiating system, among others.

Another important requirement that small cells for PSA IBW do not meet is the NEMA4 compliance requirement. Standard small cells are intended to be used in commercial or private applications and are designed to withstand exposure to dust or other external factors, but not to comply with NEMA4 or NEMA4X standards as required by PSA AHJ for any active components used on a PSA IBW system.

### Present Solutions

A small cell system may report a failure related to its operation, as a standalone unit or as an entire system (i.e., the small cell, the small cell backhaul, the small cell power supply system—main and backup, the small cell radiating system, among others), via an IP connection reporting to a server, which collects the small cell alarms, from one or a group of small cells, and has the capability to report the alarms to another system that can be a PSA server or other intended recipient. That solution, even when it meets the goal of reporting the small cell alarms and status, creates the need for the PSA AHJ to receive information from a second system different than or separate from the fire alarm panel, meaning that the AHJ would have to receive information from different, disparate sources with respect to the reliability and status of the different IBW systems installed through the AHJ area.

Further, when an AHJ requires a small cell to comply with NEMA4 or NEMA4X, current solutions rely on the placement of the small cell into a NEMA4 or NEMA4X compliant cabinet with the corresponding NEMA4 or NEMA4X compliant inlets and connectors. That solution, even if it meets the PSA AHJ NEMA4 or NEMA4X requirements, is more costly in terms of the additional hardware and labor expenditures related to placement of the small cell into the NEMA4 or NEMA4X cabinet. Another disadvantage of this approach is that placement of the small cell in such cabinets creates heat dissipation which negatively impacts the small cell operation, as the closed environment has heat dissipation constraints.

Therefore, in view of these disadvantages, there is a need in the art for an improved system and method to report a failure in small cell systems deployed as part of a PSA IBW system that complies with AHJ requirements.

### SUMMARY

The following presents a simplified summary of the invention in order to provide a basic understanding of some aspects of the invention. This summary is not an extensive overview of the invention. Rather than specifically identifying key or critical elements of the invention or to delineate the scope of the invention, its purpose, inter alia, is to present some concepts of the invention in a simplified form as a prelude to the more detailed description that is presented later.

A small cell system compliant with NEMA4 or NEMA4X standards is disclosed. The system may include a small cell; one or more backhaul connections to the small cell; one or more DC sources to power the small cell; an antenna port; first circuitry for measuring RF output power from the small cell; second circuitry for measuring VSWR between the small cell and the antenna port; third circuitry for measuring said power to the small cell from the one or more DC sources; fourth circuitry for determining the status of the one or more back haul connections; and a dry contact for outputting an alarm. The dry contact may be connected to at least one of the first, second, third or fourth circuitries.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following description of the invention when considered in conjunction with the drawings.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates a Public Safety In-Building Wireless system with a small cell and dedicated circuitry to measure RF output power in accordance with one implementation of the disclosure;

FIG. 2 illustrates a Public Safety In-Building Wireless system with a small cell with an embedded circuitry to measure RF output power in accordance with one implementation of the disclosure;

FIG. 3 illustrates a Public Safety In-Building Wireless system with a small cell and dedicated circuitry to measure VSWR in accordance with one implementation of the disclosure;

FIG. 4 illustrates a Public Safety In-Building Wireless system with a small cell with an embedded circuitry to measure VSWR in accordance with one implementation of the disclosure;

FIG. 5 illustrates a Public Safety In-Building Wireless system with a small cell and dedicated circuitry to measure DC power in accordance with one implementation of the disclosure;

FIG. 6 illustrates a Public Safety In-Building Wireless system with a small cell with an embedded circuitry to measure DC power in accordance with one implementation of the disclosure;

FIG. 7 illustrates a Public Safety In-Building Wireless system with a small cell and dedicated circuitry to determine status of backhaul links in accordance with one implementation of the disclosure;

FIG. 8 illustrates a Public Safety In-Building Wireless system with a small cell with an embedded circuitry to status of backhaul links in accordance with one implementation of the disclosure;

FIG. 9 illustrates different alarm outputs sharing the same dry contact in accordance with one implementation of the disclosure; and

FIG. 10 illustrates a small cell encased in accordance with one implementation of the disclosure.

### DETAILED DESCRIPTION

The foregoing summary, as well as the following detailed description of certain embodiments of the subject matter set forth herein, will be better understood when read in conjunction with the appended drawings. In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that variations may be made without departing from the scope of the subject matter disclosed herein. It should also be understood that the drawings are not necessarily to scale and in certain instances details may have been omitted, which are not necessary for an understanding of the disclosure, such as details of fabrication and assembly. Furthermore, references to “one embodiment” are not intended to be interpreted as excluding the existence of additional embodiments that also incorporate the recited features. The following detailed description is, therefore, not to be taken in a limiting sense, and the scope of the subject matter disclosed herein is defined by the appended claims and their equivalents.

The present disclosure describes a system that solves the problems with the prior art. The exemplary implementations disclosed herein include incorporating into a PSA IBW small cell based system additional circuitry or embedded functions that provides alarms and status outputs using standard dry contacts.

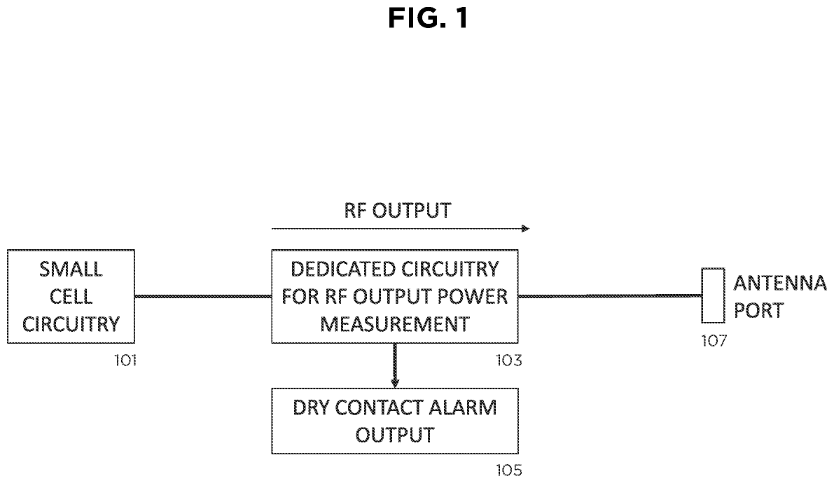

FIG. 1 illustrates a Public Safety In-Building Wireless system with a small cell and dedicated circuitry to measure RF output power in accordance with one implementation of the disclosure. Referring to FIG. 1, the PS IBW system may include a small cell and associated circuitry 101, a dedicated circuitry for measuring RF output power 103, a dry contact alarm output 105, and an antenna port 107.

The small cell 101 may be defined as a relatively inexpensive low-powered radio access node that can be placed inside a building as part of the IBW system. In one embodiment, multiple small cells 101 may be distributed throughout the building. The small cell 101 may connect directly to the cellular operator's core switching network, which means that the small cell produces a strong and reliable signal, typically having an RF output power ranging from 0.25 watts to 10 watts.

The dedicated circuitry for RF output power measurement 103 may be implemented as a dedicated chip, a field-programmable gate array, or a combination of both as would be appreciated by persons of skill in the art. In one embodiment, the dedicated circuitry RF output power measurement 103 may include a root mean square (RMS) detector, a bandpass filter, an analog-to-digital converter, and/or a timing circuitry.

The dry contact alarm output 105 may be implemented as either a normally closed or normally open dry contact that will trigger an alarm upon a change in status (from closed to open or vice versa), such as for example the dry contact alarm outputs encountered in fire alarm control panels. The antenna port 107 is used to transmit signals from the small cell 101 and through at least one service antenna in the radio distribution network.

The small cell (SC) 101 uses dedicated circuitry 103 that measures the RF output power level in order to determine if there is an RF output from the SC 101, in all the RF antenna port connections of the SC 101, comparing the measured level with a predefined or user adjustable reference value and triggering a dry contact alarm output 105 in the event the RF value is out of a range of normal RF output values which may be set by the PSA AHJ. For example, a microcontroller or other type of circuitry may be incorporated into the RF power measurement circuitry to compare the RF power measured, via a ADC, with the reference value, and in the event the RF power measured is lower, then the microcontroller will open or close the dry contact relay. FIG. 1 shows only one antenna port 107 for illustration purposes, but a SC 101 may have more than one antenna port 107 if using a MIMO topology (for example, MIMO 2:2 requires 2 different antenna ports, MIMO 4:4 requires 4 different antenna ports), and that is why in one implementation it is desirable to measure output power per antenna port. In one implementation, the output power per antenna port may be measured through use of RF power level sensors.

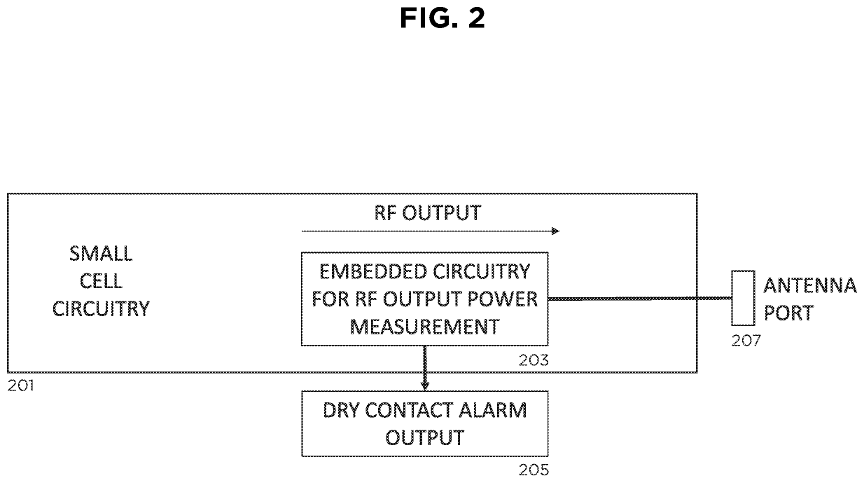

FIG. 2 illustrates a Public Safety In-Building Wireless system with a small cell 201 with an embedded circuitry 203 to measure RF output power in accordance with one implementation of the disclosure. FIG. 2 also illustrates a dry contact alarm output 205 and antenna port 207. FIG. 2 discloses the solution described in FIG. 1, but instead of a relying on a dedicated circuitry, the RF power comparison function is embedded inside the SC circuitry 201 (see embedded circuitry for RF output power measurement 203).

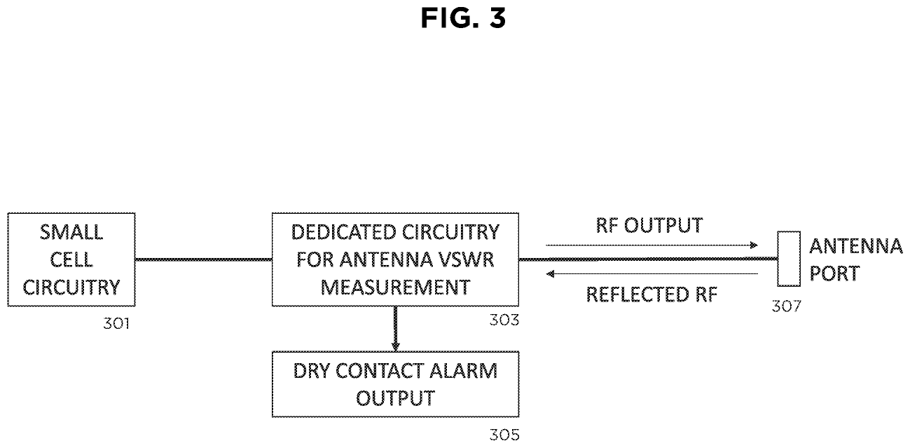

In accordance with one implementation, FIG. 3 illustrates a Public Safety In-Building Wireless system with a small cell 301, dedicated circuitry to measure VSWR 303, a dry contact alarm output 305, and an antenna port 307.

The dedicated circuitry for antenna VSWR measurement 303 may be implemented as a dedicated chip, a field-programmable gate array, or a combination of both as would be appreciated by persons of skill in the art. In one embodiment, the dedicated circuitry for antenna VSWR measurement 303 may include a forward path RMS detector, a reverse path RMS detector, and a directional bridge.

The SC 301 uses dedicated circuitry 303 that measures the RF reflected power level from the antenna 307 or antennas ports in order to determine the VSWR value at the antenna port or ports, comparing the measured level with a predefined or user adjustable reference value, and triggering a dry contact alarm output 305 in the event the VSWR value is out of a range of normal VSWR values (for example if the VSWR is higher than 2.0:1 is because there is an antenna port impedance mismatch, which is considered as a failure) which may be set by the PSA AHJ. For example the VSWR meter circuitry may include a microcontroller that reads, through ADCs and directional couplers, the value of the RF output and the reflected RF, and determines if the calculated VSWR level is higher than the reference level, in which case, the microcontroller closes/opens the dry contact relay.

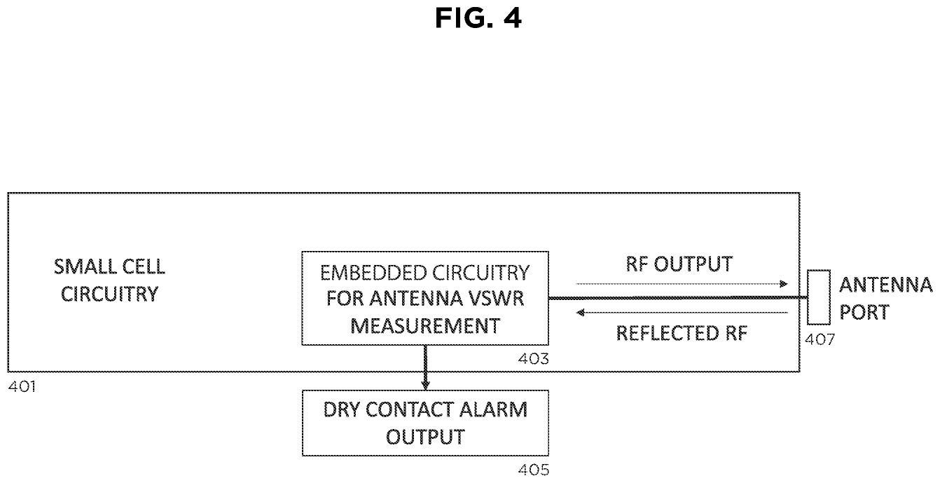

In accordance with one implementation, FIG. 4 illustrates a Public Safety In-Building Wireless system with a small cell 401 with an embedded circuitry 403 to measure VSWR. FIG. 4 also illustrates a dry contact alarm output 405 and antenna port 407. A VSWR meter may include a microcontroller with two internal ADCs, a voltage regulator to provide DC power to the microcontroller, and a LTCC coupler in which the direct and reflected RF power are coupled. The VSWR may be implemented on a 1″×1″ 4 layer PCB, including the dry contact relay.

FIG. 4 discloses the solution described in FIG. 3, but instead of a relying on a dedicated circuitry, the VSWR meter function is embedded inside the SC circuitry 401 (see embedded circuitry for VSWR measurement 403).

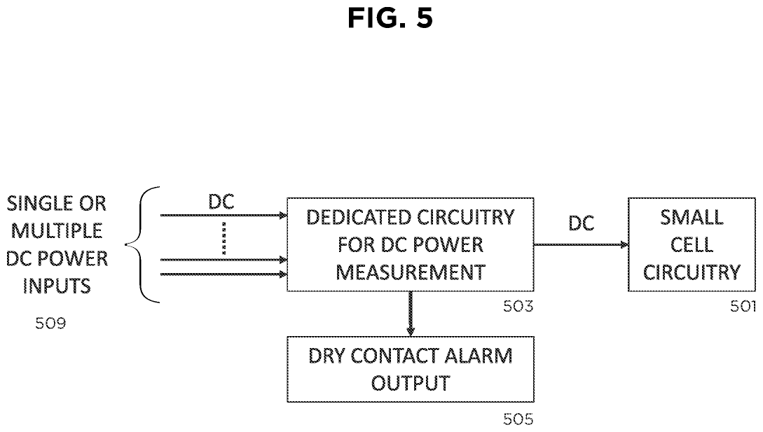

FIG. 5 illustrates a Public Safety In-Building Wireless system with a small cell 501 and dedicated circuitry 503 to measure DC power in accordance with one implementation of the disclosure. FIG. 5 also illustrates a dry contact alarm output 505 and one or more DC power inputs (e.g., main DC power and backup or redundant power sources) 509 to the small cell 501.

The SC 501 uses dedicated circuitry 503 that measures the DC power level supplied by one or more DC power inputs 509. These power inputs 509 may include the SC power supply, the main and/or backup source, and/or lines from single or multiple DC sources. The dedicated circuitry 503 compares the measured DC power level from the lines 509 with a predefined or user adjustable reference value, and triggers] a dry contact alarm output 505 in the event that the DC power level value is out of a range of normal DC values (for example, a drop of 10% in the DC power level may be considered a failed state) which may be set by the PSA AHJ. A dedicated circuitry that measures the DC power level value of each DC power source may compare the measured DC power level value with a predefined threshold or percentage in DC power drop to trigger the alarm in the event of a DC power failure, in accordance with one embodiment. For example, the dedicated circuitry that measures the DC power level value may be implemented with a microcontroller, with multiple ADCs or a single ADC and a multiplexer, that measures the DC power level and in the event it is lower than the reference value or that an unacceptable percentage drop is detected (e.g., DC power level drops by 10%), then the microcontroller closes/opens the dry contact relay.

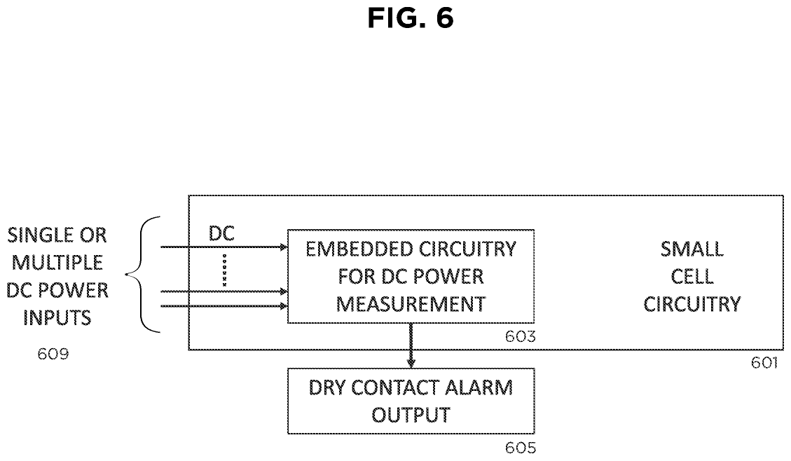

FIG. 6 illustrates a Public Safety In-Building Wireless system with a small cell 601 with an embedded circuitry 603 to measure DC power in accordance with one implementation of the disclosure. FIG. 6 also illustrates a dry contact alarm output 605 and one or more DC power inputs 609 to the small cell 601.

The solution disclosed in FIG. 6 is an implementation of the solution described with reference to FIG. 5, but instead of using dedicated circuitry, the DC power level comparison function is embedded inside the SC circuitry 601.

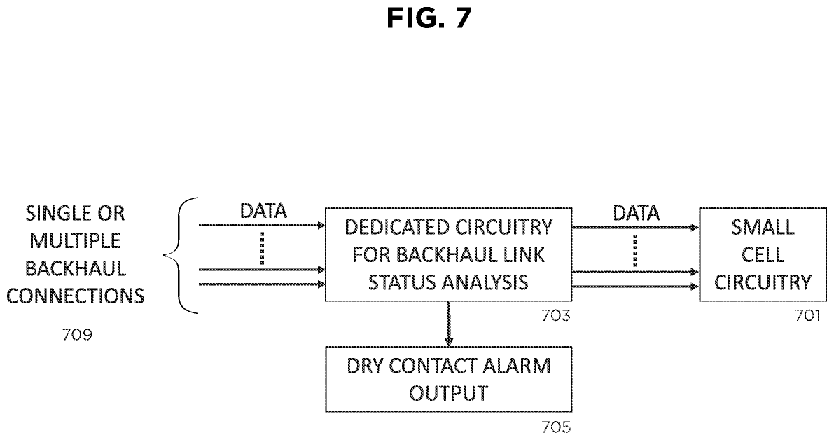

FIG. 7 illustrates a Public Safety In-Building Wireless system with a small cell 701 and dedicated circuitry 703 to determine the status of backhaul links in accordance with one implementation of the disclosure. FIG. 7 also illustrates a dry contact alarm output 705 and one or more backhaul connections 709 (e.g., main backhaul and backup backhaul connections for redundancy or resiliency purposes) to the small cell 701.

The SC 701 uses dedicated circuitry 703 that determines whether the backhaul link or links of the SC, meaning the communication link or links 709 of the SC 701 with its network, is or are properly working or not, and triggering a dry contact alarm output 705 in event that a backhaul link is not properly working. For example, the dedicated circuitry 703 that determines whether the backhaul link is properly working may include a microcontroller that acts as a TCP-IP bridge between the backhaul connection and the small cell and when the microcontroller determines that there is no connection, then the microcontroller closes/opens the dry contact relay.

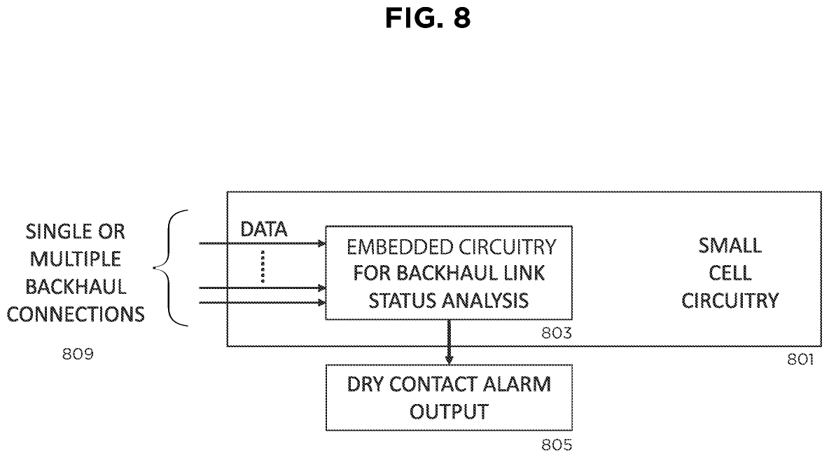

FIG. 8 illustrates a Public Safety In-Building Wireless system with a small cell 801 with an embedded circuitry 803 to determine status of backhaul links in accordance with one implementation of the disclosure. FIG. 8 also illustrates a dry contact alarm output 805 and one or more backhaul connections 809 to the small cell 801.

The solution disclosed in FIG. 8 is an implementation of the solution described with reference to FIG. 7, but instead of using dedicated circuitry, the circuitry 803 for determining the status of the backhaul link is embedded inside the SC circuitry 801.

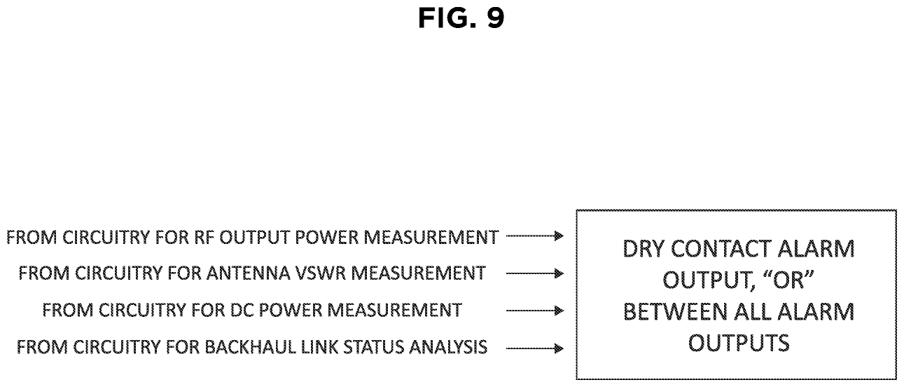

FIG. 9 illustrates different triggers for alarm outputs (from the description above) sharing the same dry contact alarm output in accordance with one implementation of the disclosure. For example, the dry contact alarm outputs listed or described above may be implemented as independent dry alarm contacts, or different alarm outputs may be triggered by sharing the same dry contact, creating an “OR” single output or different “OR” outputs.

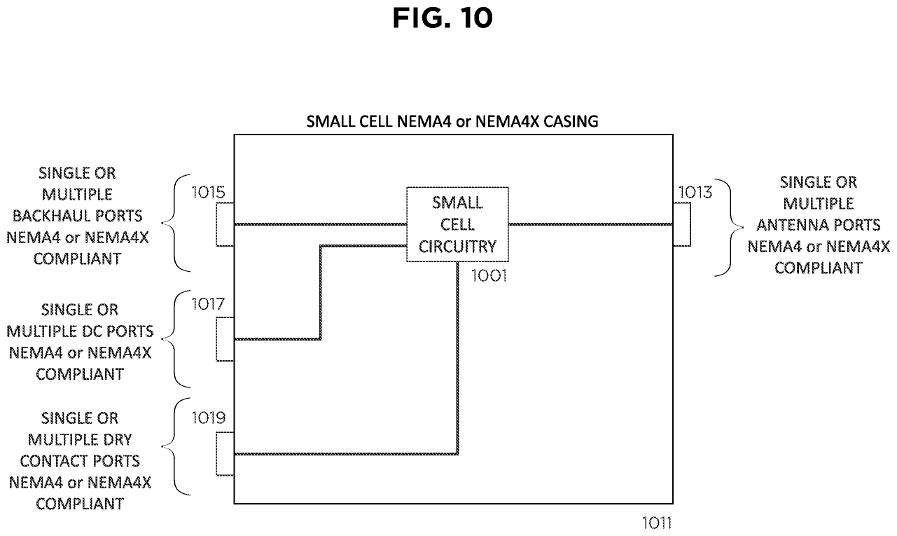

FIG. 10 illustrates a small cell 1001 encased in accordance with one implementation of the disclosure. The exemplary implementations disclosed herein include providing the SC 1001 with a NEMA4 or NEMA4X compliant casing with the NEMA4 or NEMA4X compliant inlets and connectors, in order to meet the NEMA4 or NEMA4X requirements of the PSA AHJ without the need of placing the small cell 100 inside another cabinet or case, while at the same time providing the SC 1001 with the proper heat dissipation characteristics that do not minimize the SC working temperature range. For example, if a small cell or any other active component is placed inside a closed cabinet, the air inside the cabinet will get warmer than the air outside the cabinet, meaning that inside the cabinet the temperature will be higher than the ambient temperature. If the cabinet does not provide heat dissipation to the small cell and the heat dissipation is effected through the cabinet internal air, the air will get warm and the small cell will more quickly reach its maximum operational temperature, while if the cabinet acts as a heat sink to the small cell, then the inside air will not reach such a higher temperature. These inlets and connectors may include NEMA4 or NEMA4X compliant backhaul ports 1015, NEMA4 or NEMA4X compliant DC input power ports 1017, NEMA4 or NEMA4X compliant dry contact connectors 1019, and NEMA4 or NEMA4X compliant antenna ports 1013.

In one implementation, the SC 1001 may be enclosed within a metal sheet NEMA4 or NEMA4X casing with NEMA4 or NEMA4X compliant inlets and connectors. In one implementation, the SC 1001 may be enclosed within a metal die casted NEMA4 or NEMA4X casing with NEMA4 or NEMA4X compliant inlets and connectors. In one implementation, the SC 1001 may be enclosed within a metal molded NEMA4 or NEMA4X casing with NEMA4 or NEMA4X compliant inlets and connectors. In one implementation, the SC 1001 may be enclosed within a plastic NEMA4 or NEMA4X casing with NEMA4 or NEMA4X compliant inlets and connectors. In one implementation, the SC 1001 may be enclosed within a metalized finished plastic NEMA4 or NEMA4X casing with NEMA4 or NEMA4X compliant inlets and connectors.

The foregoing description of possible implementations consistent with the present disclosure does not represent a list of all such implementations or all variations of the implementations described. The description of some implementations should not be construed as an intent to exclude other implementations described. For example, artisans will understand how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention being indicated by the following claims. Further, the limitations of the following claims are not written in means—plus-function format and are not intended to be interpreted based on 35 U.S.C. 112(f), unless and until such claim limitations expressly use the phrase “means for” followed by a statement of function void of further structure.

1. A small cell system compliant with NEMA4 or NEMA4X standards, the system comprising:
a small cell;
one or more backhaul connections to the small cell;
one or more DC sources to power the small cell;
an antenna port;
first circuitry for measuring RF output power from the small cell;
second circuitry for measuring VSWR between the small cell and the antenna port;
third circuitry for measuring said power to the small cell from the one or more DC sources;
fourth circuitry for determining the status of the one or more back haul connections;
and a dry contact for outputting an alarm, said dry contact connected to at least one of the first, second, third or fourth circuitries.

2. The system of claim 1, wherein at least one of said first, second, third or fourth circuitries is a dedicated circuitry.

3. The system of claim 1, wherein at least one of said first, second, third or fourth circuitries is embedded with the small cell.

4. The system of claim 1, wherein said first circuitry comprises a microcontroller that compares measured RF output power with a predefined RF output power threshold and triggers the dry contact to generate an alarm when the measured RF output power falls under the predefined RF output power threshold.

5. The system of claim 1, wherein said second circuitry comprises a microcontroller that compares measured VSWR with a predefined VSWR threshold and triggers the dry contact to generate an alarm when the measured VSWR exceeds the predefined VSWR threshold.

6. The system of claim 1, wherein said third circuitry comprises a microcontroller that compares measured DC output power from said one or more DC sources with a predefined DC output power threshold and triggers the dry contact to generate an alarm when the measured DC output power falls under the predefined RF output power threshold.

7. The system of claim 1, wherein said fourth circuitry comprises a microcontroller that triggers the dry contact to generate an alarm when it determines a failed status of the one or more back haul connections.

8. The system of claim 1, wherein said first circuitry comprises a microcontroller that compares measured RF output power with a predefined RF output power threshold and generates a first alarm signal when the measured RF output power falls under the predefined RF output power threshold;
wherein said second circuitry comprises a microcontroller that compares measured VSWR with a predefined VSWR threshold and generates a second alarm signal when the measured VSWR exceeds the predefined VSWR threshold;
wherein said third circuitry comprises a microcontroller that compares measured DC output power from said one or more DC sources with a predefined DC output power threshold and generates a third alarm signal when the measured DC output power falls under the predefined RF output power threshold; and
wherein said fourth circuitry comprises a microcontroller that generates a fourth alarm signal when it determines a failed status of the one or more back haul connections, and wherein the first, second, third, and fourth alarm signals are input to an OR logic circuit to trigger the dry contact alarm.

9. The system of claim 1, wherein the small cell is enclosed in a NEMA4 casing.

10. The system of claim 1, wherein the small cell is enclosed in a NEMA4x casing.

11. The system of claim 9, wherein said NEMA4 casing comprises a metal sheet.

12. The system of claim 9, wherein said NEMA4 casing comprises a metal die cast.

13. The system of claim 9, wherein said NEMA4 casing is metal molded.

14. The system of claim 9, wherein said NEMA4 casing comprises plastic.

15. The system of claim 9, wherein said NEMA4 casing comprises metalized plastic.

16. The system of claim 10, wherein said NEMA4x casing comprises a metal sheet.

17. The system of claim 10, wherein said NEMA4x casing comprises a metal die cast.

18. The system of claim 10, wherein said NEMA4x casing is metal molded.

19. The system of claim 10, wherein said NEMA4x casing comprises plastic.

20. The system of claim 10, wherein said NEMA4x casing comprises metalized plastic.
